(19) United States
(12) Patent Application Publication
(10) Pub. No.: US 2006/0112146 A1
(43) Pub. Date: May 25, 2006

(54) Systems and methods for data analysis and/or knowledge management

(75) Inventors: Xiaodan Song, Seattle, WA (US); Belle Tseng, San Jose, CA (US)

Correspondence Address: NEC LABORATORIES AMERICA, INC., 4 INDEPENDENCE WAY, PRINCETON, NJ, 08540, US

(73) Assignee: NEC Laboratories America, Inc., Princeton, NJ (US)

(21) Appl. No.: 11/094,235

(22) Filed: Mar. 31, 2005

Related U.S. Application Data
(60) Provisional application No. 60/630,050, filed on Nov. 22, 2004.

(51) Int. Cl. G06F 17/30

(52) U.S. Cl. 707/200

(57) ABSTRACT

The present invention is directed to systems and methods for data and/or information analysis. The systems and methods may be directed to knowledge management and/or user modeling. In various embodiments, the systems and methods may utilize relational representations and/or evolutionary representations of information. For example, expertise information and/or evolutional information related to expertise information may be analyzed and representations presented indicating relationships and temporal evolution.

This application claims the benefit of U.S. Provisional Application No. 60/630,050, filed Nov. 22, 2004, the entire disclosure of which is hereby incorporated by reference as if set forth fully herein. This application is related to recently filed patent application having attorney docket number 04023 (not yet assigned a serial number), the entire disclosure of which is hereby incorporated by reference as if set forth fully herein.

This disclosure contains information subject to copyright protection. The copyright owner has no objection to the facsimile reproduction by anyone of the patent disclosure or the patent as it appears in the U.S. Patent and Trademark Office files or records, but otherwise reserves all copyright rights whatsoever.

### BACKGROUND OF THE INVENTION

The present invention is related to systems and methods for data and/or information analysis, in particular for knowledge management and/or user modeling.

Analysis of data compilations, including statistical analysis of relationships in the data and future trend analysis, is an area of wide application. For example, in a typical enterprise setting, information regarding entities such as employees is usually manually updated, which often results in data of poor quality. Individuals may provide incomplete profiles, or may not invest the necessary effort in creating a rich and accurate profile of themselves, or may not keep the data up-to-date as their interests, responsibilities, and expertise changes. Individuals, at best, often provide a few keywords on expertise, making it difficult to differentiate who are the better experts from many people with similar expertise. For example, for a manager who is in charge of multiple groups with different responsibilities and capabilities, it is desirable to have this information in hand. For service personnel facing customer problems, it is desirable to be able to draw on the problem-solving expertise of all of the individuals within the organization. An internal expertise mining system would be an advantageous tool for understanding and managing the expertise and potentials of individuals within an enterprise—which usually are the most valuable assets in enterprises.

The field of “knowledge management” is receiving recognition as the gains to be realized from the systematic effort to store and export vast knowledge resource held by employees of an organization are being recognized. The sharing of knowledge broadly within an organization offers numerous potential benefits to an organization through the awareness and reuse of existing knowledge, and avoidance of duplicate efforts. In order to maximize the exploitation of knowledge resources within an organization, a knowledge management system may be presented with two primary challenges, namely (1) the identification of knowledge resources within the organization and (2) the distribution and accessing of information regarding such knowledge resources within the organization. In contrast to systems where individuals manually input their expertise information, it has been proposed to build such expertise profiles passively, i.e. by analyzing e-mail messages and other content source in order to build a representative profile of a person or entity. Traditional information retrieval techniques have been applied to address the problems of expertise matching and mining. See P. Liu, J. Curson, P. M. Dew, “Exploring RDF for Expertise Matching Within an Organizational Memory,” Conference on Advanced Information Systems Engineering, pp. 100-116 (2002); A. Mockus, J. D. Herbsleb, “Expertise Browser: A Quantitative Approach to Identifying Expertise,” Proceedings of the 24^{th} International Conference on Software Engineering, pp. 503-512 (May 2002). However, prior art approaches have usually described expertise as a vector, which can fail to provide a richer and more accurate description of an entity's expertise. Often there is no explicit description of the relationship among the different categories of expertise, nor of the evolution of the expertise.

### SUMMARY OF INVENTION

Systems and methods for data and/or information analysis are disclosed herein which may be directed to knowledge management and/or user modeling and may utilize relational representations and/or evolutionary representations of information, for example, expertise information. In contrast to prior art vector-based approaches, expertise profiles may be represented as, for example, graphs. Evolutionary social network models and exponential random graph models may be incorporated into a user model analysis. For example, the personalized social network for an individual, which includes how other individuals evaluate her and how she evaluates herself as well as other individuals, may be used to construct the expertise profile. The context semantics may be assumed to evolve, due to interaction of the entity with different multi-modal information sources, such as text and citation links. Classification and clustering techniques may be used to address detection of concepts and the structural and semantic units comprising the context model. Classification accuracy may be boosted by utilizing the citation linkages between texts in the classification methodology. The knowledge management system, accordingly, may utilize an expertise representation that explicitly provides relational and/or evolutional information for user modeling. Since the relationship information and the temporal evolution of the expertise are explicitly modeled, a richer and more accurate description of an entity's expertise may be provided, which may be useful for mining, retrieval, and visualization. The knowledge management system may also provide innovative mechanisms for analyzing and indexing multiple disparate modalities in order to extract relationships/correlations across the heterogeneous information source related to an entity.

The present invention may introduce social network concepts into user modeling. A user-centric modeling approach is disclosed which may be used to dynamically describe and update an expertise profile. The present invention may enhance collaboration and productivity in an enterprise environment, e.g., by quickly finding entities with complementary expertise, or entities with a specified expertise. These and other advantages of the invention will be apparent to those of ordinary skill in the art by reference to the following detailed description and the accompanying drawings.

### BRIEF DESCRIPTION OF DRAWINGS

FIG. 1A is a diagram illustrating processing performed by a knowledge management system, in accordance with at least one embodiment of the present invention.

FIG. 1B is a diagram illustrating one possible system diagram for a knowledge management system, in accordance with at least one embodiment of the present invention.

FIG. 2 illustrates how linkage information can associate textual classifications, in accordance with at least one embodiment of the present invention.

FIGS. 3A and 3B are diagrams illustrating a few processes of constructing a relational representation of the expertise information, in accordance with at least one embodiment of the present invention.

FIG. 4 is a diagram illustrating the process of constructing an evolutionary representation of the expertise information, in accordance with at least one embodiment of the present invention.

FIGS. 5 and 6 are illustrative relational and evolutionary representations, respectively, constructed from a computer science publication corpus, in accordance with at least one embodiment of the present invention.

FIG. 7 is an illustration of expertise relationship mining, in accordance with at least one embodiment of the present invention.

FIG. 8 is an illustration of evolutionary expertise mining, in accordance with at least one embodiment of the present invention.

FIG. 9 is an illustration of expertise matching, in accordance with at least one embodiment of the present invention.

### DETAILED DESCRIPTION

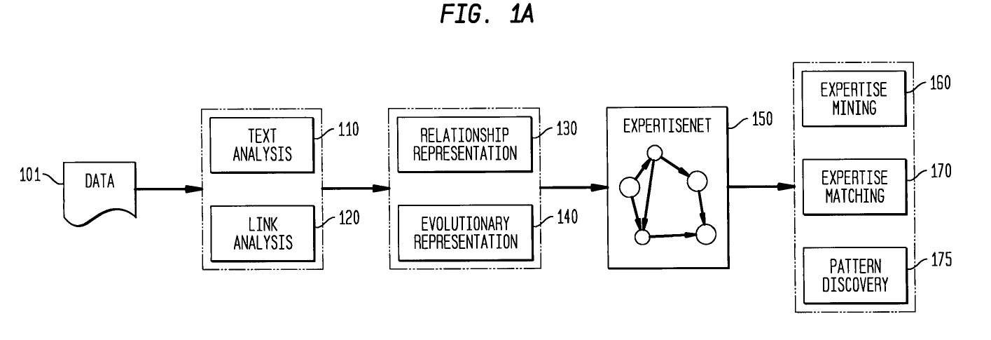

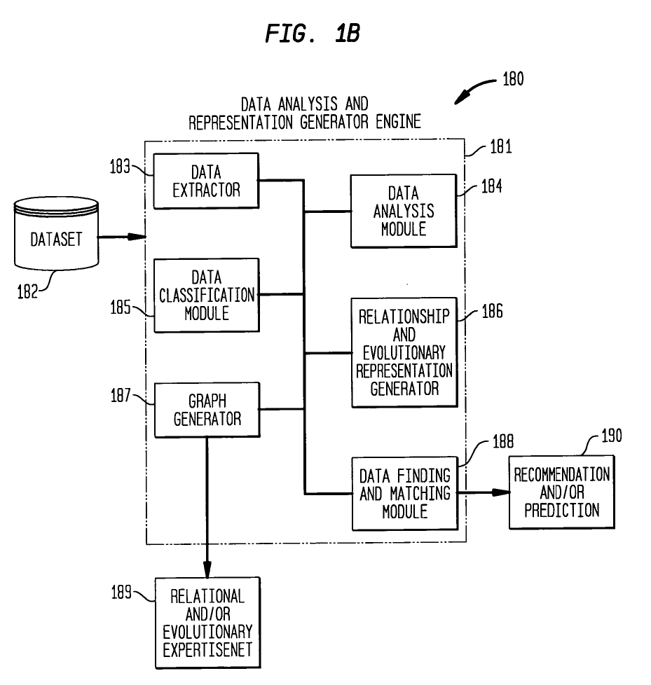

The present invention is directed to systems and methods for data and/or information analysis. The systems and methods may be directed to knowledge management and/or user modeling. In various embodiments, the systems and methods may utilize relational representations and/or evolutionary representations of information, for example, expertise information and/or evolutional information related to expertise information. The systems and methods may be at least in part included in, for example, a computer system, a computer network, the Internet and/or a computer readable medium. Various exemplary embodiments are provided herein to illustrate at least some of the possible applications for the present invention, but the invention is not limited thereto. For example, FIG. 1A is a diagram illustrating processing performed by a knowledge management system in accordance with at least one embodiment of the present invention. At 101, data is received by the system, preferably in some textual format and with some form of associated relational information. For example, and without limitation, the data can be in the form of a textual representation of various publications written by the individuals to be analyzed along with citation links between texts. It should be noted that an alternative embodiment is discussed below where the linkage information is not directly available and is inferred from the textual information.

At 110 in FIG. 1A, expertise information is extracted by known text classification techniques. For example, and without limitation, advantageous text classification algorithms, such as ADABOOST, can be utilized for expertise detection. See Robert E. Schapire, “The Boosting Approach to Machine Learning: An Overview,” in MSRI Workshop on Nonlinear Estimation and Classification (2002), which is incorporated by reference herein. The basic idea of a “boosting” algorithm is to find a “strong hypothesis” by combining many “weak” hypotheses, which is suitable for fusing features in different forms. The prior art has typically extracted expertise using merely the words from the title and abstract of a publication. In FIG. 1, after pre-processing which excludes “stop words” and “stemming,” the citation linkages are also used as features for classification, at 120. For example, the citation linkage feature can be defined as follows:
P(X=x)=mₓ/M
where X is a variable which indicates the citation information for each publication, x represents one of the categories, mₓ is the number of citations belonging to the category x, and M is the number of references. The intuition behind incorporating these features is that a paper from one category tends to cite the papers in the same area. This relational structure is useful for classification. It can be shown that incorporating this feature can boost the classification accuracy significantly.

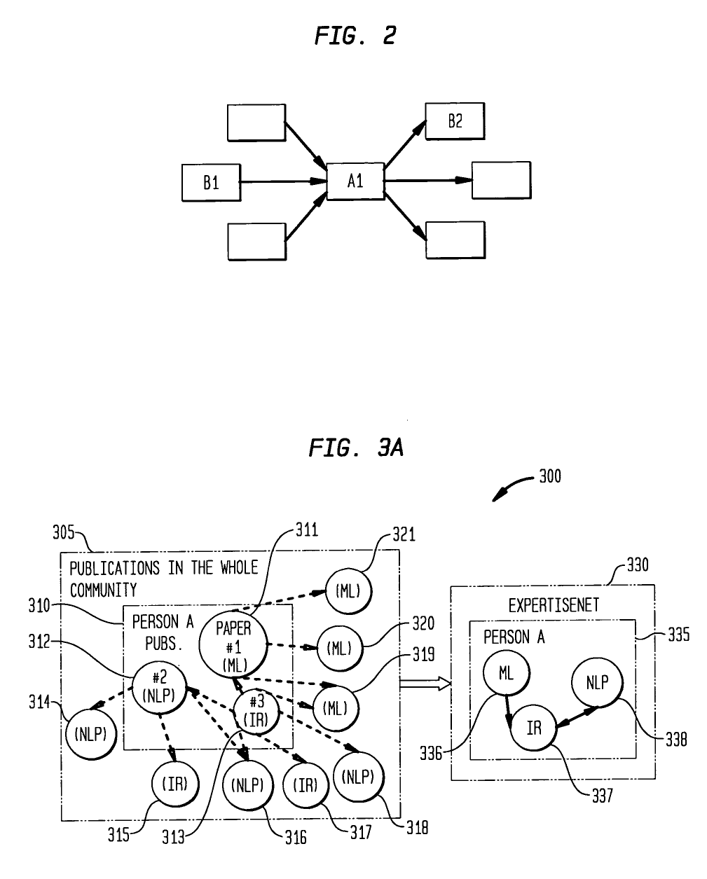

After analyzing the textual data and the linkages, the knowledge management system will have a representation of the expertise information that categorizes the different publications and linkages. For example, FIG. 2 illustrates how linkage information can associate the different textual classifications. In FIG. 2, paper “A1” is one of the papers in category “A”. It cites paper “B2“, which is one of the papers in category “B”, and another paper from category “B”, namely “B1“, cites paper “A1”. The inventors refer to the linkage from “A1” to “B2“as an “out-direction” citation linkage, and the linkage from “B1” to “A1” as an “in-direction” citation linkage.

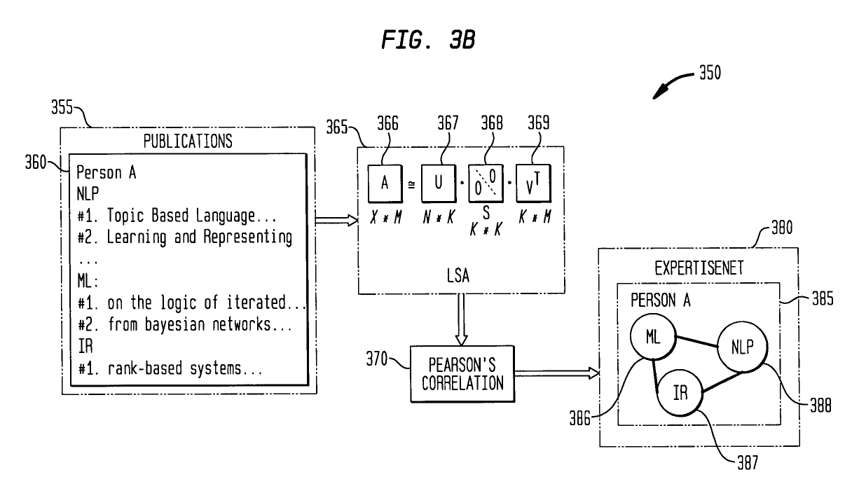

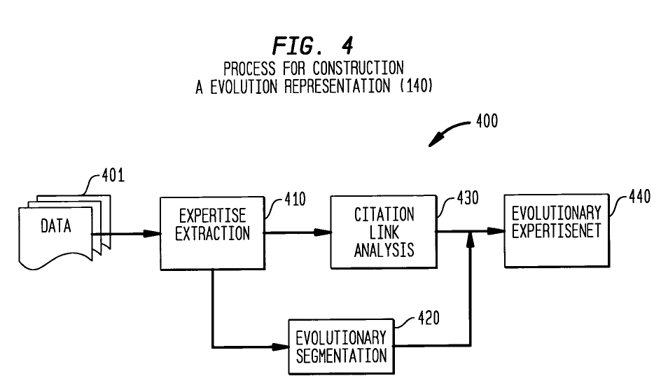

As illustrated in FIG. 1A, and in accordance with at least one embodiment of the invention, this expertise information is used to extract what will be referred to herein as a “relationship representation” 130 and an “evolutionary representation” 140 of the expertise information. The combined representation is an expertise profile for one or more entities/individuals which is referred to herein as an “EXPERTISENET” 150 in FIG. 1A. An exemplary system diagram according to at least one embodiment is shown in FIG. 1B. The detailed processing entailed in constructing a relationship representation is illustrated by FIGS. 3A and/or 3B. The detailed processing entailed in constructing an evolutionary representation is illustrated by FIG. 4.

At least one embodiment of the data analysis and/or knowledge management system 180 according to the present invention may be as shown in FIG. 1B. Referring to FIG. 1B, the system 180 may include a data analysis and representation generator engine 181. The engine 181 may receive input data from a dataset 182. In at least one embodiment, the dataset 102 may include, for example, information related to publications, for example citation, text, etc. information for multiple publications. However, the dataset 182 may be any data corpus in which the items thereof include interrelationships. The engine 181 may include a data extractor 183, a data analysis module 184, a data classification module 185, a relationship and/or evolutionary representation generator 186, a graph generator 187, and a data finding and matching module 188. The graph generator 187 may output relational and/or evolutionary representation reports 189, that may include a graph, to a user as described herein. Further, the graph generator 187 may include a graphical user interface (GUI) to display the report to the user. The data finding and matching module 188 may output recommendation and/or prediction 190 information to a user.

In at least one embodiment, the data extractor 183 may receive input information from the dataset 182. The dataset may be co-located or remote to the engine 181. The data extractor 183 may analyze the input data for the presence or absence of one or more characteristics or features deemed to be of interest to the user. In at least one embodiment, the data extractor 183 may compile the extracted information of interest that is associated with a particular person or group into a profile for that person or group. The data extractor 183 may utilize a variety of extraction techniques such as, for example, pattern recognition and/or image analysis techniques.

The data analysis module 184 may receive the information from the data extractor 183 and may generate a ranking for the person or group associated with a desired characteristic or classification. In an embodiment, the data analyzer 184 may determine a strength of relationship or evolution based on, for example, the quantity and quality of the characteristics present for the various entities of interest. The data analyzer 184 may base the analysis on a comparison of each characteristic found to a search query that specifies desired characteristic(s). The data classification module 185 may classify the data into various categories according to a user query. The data may also be classified according to temporal information. In at least one embodiment, the relationship and/or evolutionary representation generator 186 may generate a representation of relationship and/or evolutionary aspects of the data and characteristics that result from a user query. This information may be in various forms, for example, a table or list and may include weighting of various characteristics and interrelationships. In at least one embodiment, the graph generator 187 may generate a relational and/or evolutionary network representation, for example, an ExpertiseNet to display the results of a user query. This may include, for example, the relationships for a person or group in a give timeframe or as may be observed over time. In at least one embodiment, the data finding and matching module 188, may provide recommendations and/or predictions regarding the various user queries. It should be recognized that the present system may be included in a computer system or network such as a PC, an intranet, or the Internet. Further, software to operate the system may be included on a computer readable medium and may be done using, for example, C++ programming language, etc. Operation of the system components will be described in more detail below.

FIGS. 3A and 3B sets forth diagrams illustrating a couple of processes of constructing the relational representation 130 of the expertise information, in accordance with various embodiments of the present invention. Social structure may be conceptualized as a system of social relations tying distinct social entities to one another. A social network is an attempt to represent the social relations via networks. The relational representation 130 of the expertise information recognizes the fundamental role of the relational information. It is based on the premise that social context is an important determinant of individual behavior. It seeks to understand individual and group behavior in terms of relational information rather than as solely the aggregation of individual characteristics.

The relational representation 130, as may be derived using various processes such as those shown in FIGS. 3A and 3B, may be formulated as, for example, a set of nodes (n) and edges (e) or links. Each node may represent, for example, an expertise area of an entity/person, as determined by one or more of the above-mentioned classification techniques, while the edges may represent, for example, the relationships between the expertise areas.

The relational representation 130, for example, can be formulated as G(N, E), where N represents the nodes set and E represents the edge set. Two nodes ni and nj are adjacent if edge eij=(ni, nj), or eji=(nj, ni) is in the set of edges E. In the relational ExpertiseNet, each node may represent, an expertise. The size of a node may be proportional to the strength of the node which is defined as:
sᵢ=Pᵢ
where sᵢ represents the strength of the expertise i for the person, pᵢ is the number of publications of the person in category i resulted from classification, as described above. The edges may represent the relationship between the expertise nodes. Two types of relational ExpertiseNets may be defined: Directed ExpertiseNet and Undirected ExpertiseNet. When the database contains citation linkage information, directed ExpertiseNets may be built in which the edges have directions to indicate the directions of influences between the expertises. When the database does not contain citation linkage information, Undirected ExpertiseNets may be built in which the edges do not have directions.

It is advantageous to use the correlations among different categories to decide the edges of the representation. The text and citation linkages provide possibilities to build the edges. Citation linkages can provide solid evidence of correlations among different expertise. For example, a paper in category “A” cites many papers in category “B”, this implies the close relationship of category “A” and category “B” for this paper. As discussed above, the dataset contains linkages which include both the information of how a paper cites other papers (out-direction) and how other papers cite this paper (in-direction). This information regarding the types of linkages can be advantageously utilized. For example, authority typically comes from in-edges, while being a good “hub” comes from out-edges. From the publications of a person A, it is reasonable to infer that her expertise “X” is influenced by “Y” if her papers in category “X” cite many papers from the category “Y”, while her expertise “X” influences “Y” if her papers in category “X” are cited by papers from category “Y”. For example, in FIG. 3A, one exemplary process for generating a relational representation is provided which may use citations within various research papers. The entire publications 305 of an entire area or community may be analyzed. In this case, a first person's, Person A, publications 310 include, for example, paper #1 (311) from Machine Learning (ML), paper #2 (312) from Natural Langrage Processing (NLP), and paper #3 (314) from Information Retrieval (IR) respectively. Each paper may cite various other papers. For example, paper #2 (312) cites three papers, one paper in NLP 314 and one paper in IR 315 and one in NLP 316 (indicated by the out-direction edges). Further, paper #1 (311) cites three papers in ML, ML 319, ML 320, and ML321. We may infer that for this person, his/her NLP expertise is influenced by NLP, ML, and IR, and at the same time, affects IR. With this consideration, the strengths of the edges of the relational ExpertiseNet may be determined by:

$${e}_{A \to B} = \frac{( \frac{{\sum }_{i = 1}^{K} {n}_{iAB}}{{N}_{i}} )}{K}$$

where e_{A→B} represents the “strength” of the edge from expertise “A” to expertise “B”, K is the total number of publications for the person, n_{iAB} represents for paper i the number of papers in category A cited by the papers in category B, Ni represents the number of citations in paper i. From this and ExpertiseNet 330 may be constructed for person A 335. Person A 335 has expertise in ML 336, IR 337, and NLP 338 that may be interrelated as shown in FIG. 3A.

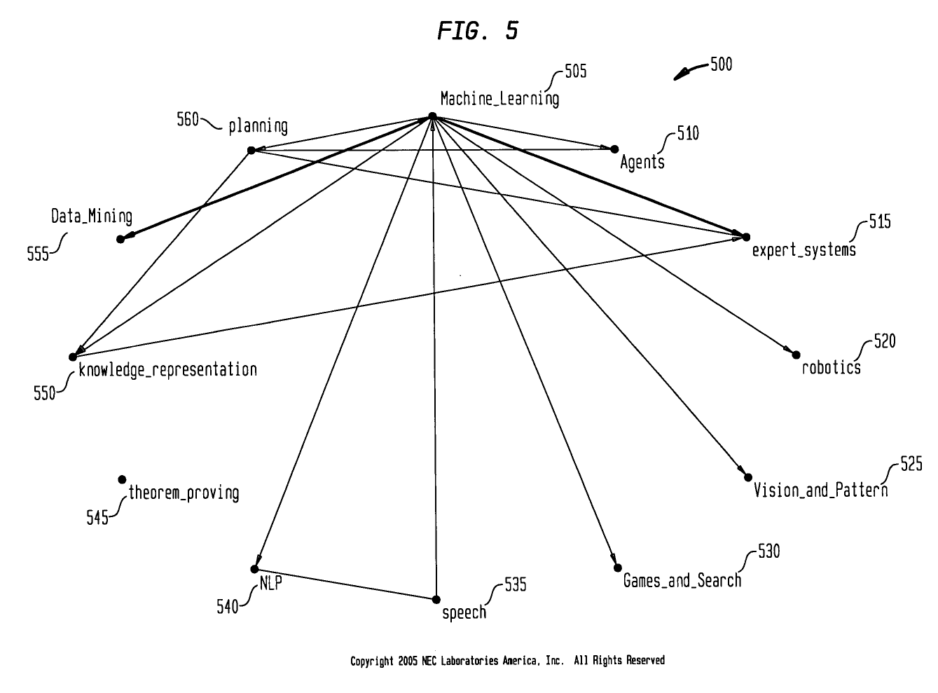

FIG. 5 sets forth an illustrative relational representation 500, constructed from a computer science publication corpus. It can be seen from this graphical representation of the model that “machine learning” (505) is the central research area of this particular community, since it highly interacts with other research areas. Among all of the other research areas, “data mining” (555) and “expert systems” (515) are two highly influencing areas. “Theorem proving” (545) is another extreme: it develops by itself while seldom interacting with other research areas. “Machine learning,” (505) “NLP” (540), and “speech” (535) seem to compose a clique, which means that they contribute a lot to each other while interacting very little with the outside. If one were to need to find an individual or entity with expertise in the area of “knowledge representation,” assuming that no one in an enterprise had such expertise, one can readily ascertain from the relational representation 500 that other possible candidates would be from the “expert systems (515),” “planning” (560) or “machine learning” (505) areas.

In at least one embodiment, alternative or additional methods for determination between nodes may be used. For example, the correlation between nodes may be explored by text similarity analysis. This may be particularly useful when the citation linkages are not available. For example, Latent Semantic Analysis (LSA) 350 and “covariance graph” models may be applied on, for example, the term-by-document matrix (the columns of the matrix are the indices of the documents, and the rows of the matrix contains the frequency of occurrence of the terms in the documents), to build the undirected ExpertiseNet 380 as shown in FIG. 3B. See, e.g., S. Deerwester, S. T. Dumais, G. W. Furna, T. K. Landauer and R. Harshman, “Indexing by Latent Semantic Analysis,” Journal of the American Society for Information Science (1990); P. E. Foltz, W. Kintsch, and T. K. Landauer, “The Measurement of Textual Coherence with Latent Semantic Analysis,” Discourse Processes 24, pp. 285-307 (1998); D. R. Cox, and N. Wermuth, “Multivariate dependencies,” London: Chapman & Hall, (1996), which are incorporated by reference herein. LSA is a method for extracting and representing the contextual meaning of words. It has been used as a technique to measure the coherence of texts. By comparing the vectors formed by the keywords of two documents in a high-dimensional semantic space, this method may provide a characterization of the degree of semantic relatedness between documents. LSA 365 may decomposes the term-by-document matrix into three matrices by a truncated singular value decomposition (SVD) which performs the optimal least-square projection of the original space onto a space with a reduced dimension K:
A≅USV^{T}
where AεR^{N×M}, UεR^{N×K}, SεR^{K×K}, and VεR^{M×K}, M is the number of documents, and N is the number of terms. Here, since the process is, for example, to compare the person's expertises in different categories, in the term-by-document matrix, all the words from all publications 355 in one category for the person may be treated as one document 360. The “covariance graph” model may be applied to build relevance networks, such as the gene relevance networks where interactions between any two genes are defined through Pearson's correlation coefficients 370. This “covariance graph” model may be applied on the reconstructed matrix. First, the correlation matrix may be calculated to determine the strengths of the edges between two nodes in the undirected relational ExpertiseNet 380, then, if the magnitude of the value of the correlation is smaller than a threshold (we set, for example, 0.05), we eliminate that edge from the graph. An example of the resultant undirected ExpertiseNet 380 is shown in FIG. 3B. In this case, the network for person A 385 includes ML 386, IR 387, and NLP 388 areas interconnected with one another.

It may be advantageous to incorporate exponential random graph models into the above user model analysis. The above analysis can be used to obtain an observation of the user expertise profile. Then, an exponential random graph model (otherwise known as a “p* model”) can be used to estimate an underlying distribution to describe the relational representation 130 of the expertise information. One advantage of this statistical model is that it can be used to represent structural tendencies, such as transitivity (defined by the number of transitive patterns) that define complicated dependence patterns not easily modeled by deterministic models. Given a set of n nodes, let Y denote a random graph on these nodes and y denotes a particular graph on those nodes. Then

$${P}_{θ} ( Y = y ) = \frac{exp ( {θ}^{T} s ( y ) )}{c ( θ )}$$

where θ is an unknown vector of parameters, s(y) is a known vector of graph statistics on y Density (defined by the out-degrees), reciprocity (defined by the number of reciprocated relations), and transitive triads (defined by the number of a set of edges {(i→j), (j→k), (i→k)}) and the attributes of the nodes are considered herein), c(θ)is a normalization term. This probabilistic expression has advantages on describing the insights of the network, and, thus, can also help to describe the evolution of the expertise representation.

In the evolutionary representation 140, the dynamics and/or the evolution of expertises may be explored and considered. In evolutionary representation, two basic tasks are performed: (1) “evolution segmentation,” where changes are detected between expertise cohesive sections and/or (2) “expertise tracking,” where one keeps track of expertise similar to a set of previous expertise. The strength of the nodes as well as the structure of the network may be considered in evolution segmentation, and temporal sliding windows may be applied. The development of one expertise may, in fact, depend on or influence the development of others. For example, it has been determined that when a research area increases its citations from other areas, it can predict the development of this area for a period of time into the future. A possible reason for this phenomenon is that when a new branch in a traditional research area is being developed, at the beginning stage, it usually borrows ideas from other areas. When the branch of research comes to a mature period, the researchers will tend to cite the papers in its own area. Thus, it is reasonable to assume that there are correlations between the development of the expertise areas and the linkage changes.

FIG. 4 sets forth a diagram illustrating the process of constructing the evolutionary representation 400 of the expertise information, in accordance with at leastg one embodiment of an aspect the present invention. After expertise extraction is performed at 410 on the data 401, it may be advantageous to perform evolutionary segmentation at 420. In evolutionary segmentation 420, multiple expertises are segmented by detecting changes over time. For example, the change points can be determined by:

$${\sum }_{i = 1}^{L} \vert {V}_{t , i} - {V}_{t - 1 , i} \vert > th$$

where V_{t,i} indicates the “strength” of the expertise i at time t, L indicates the number of expertises for each person, th is a threshold, where the goal is to find all t satisfied by the equation. It has been found it advantageous to set the threshold th to, for example, 0.2. [Is there a range of reasonably good choices?] The evolution segments may be obtained from these change points.

As discussed above, it has been determined that the link changes are often highly correlated with the evolution of the expertise. Accordingly, at 430 in FIG. 4, expertise tracking may be performed by conducting an analysis of the citation linkages. The tracking edges may be determined, for example, by

$${e}_{{A}_{t - 1} \to {B}_{t}} = \frac{( \frac{{\sum }_{i = 1}^{{K}_{t}} {n}_{i {A}_{t - 1} {B}_{t}}}{{N}_{i , t}} )}{{K}_{t}}$$

where the variables have the same meaning as above, except that only the papers in a particular time segment t are considered.

In at least embodiment, an exponential random graph model can be estimated from the data in each window of time or time period, where temporal sliding windows may be applied. A series of parameters which indicate the network configurations can be obtained. Then, the change points of the evolutionary representation are determined by:

$${\sum }_{k = 1}^{M} \vert {θ}_{t , k} - {θ}_{t - 1 , k} \vert > th$$

where θ_{t,k} indicates the parameters of the exponential random graph model at time t, M represents the number of parameters, and th is a threshold. The goal may be to find all t that satisfied the equation based on a particular th. The threshold, th, may be, for example, from 0.1 to 0.3 for satisfactory evolutionary representation 400 results. Regardless of which approach(s) for evolutionary representation 600 may be used, at 440 and Evolutionary ExpertiseNet may be developed.

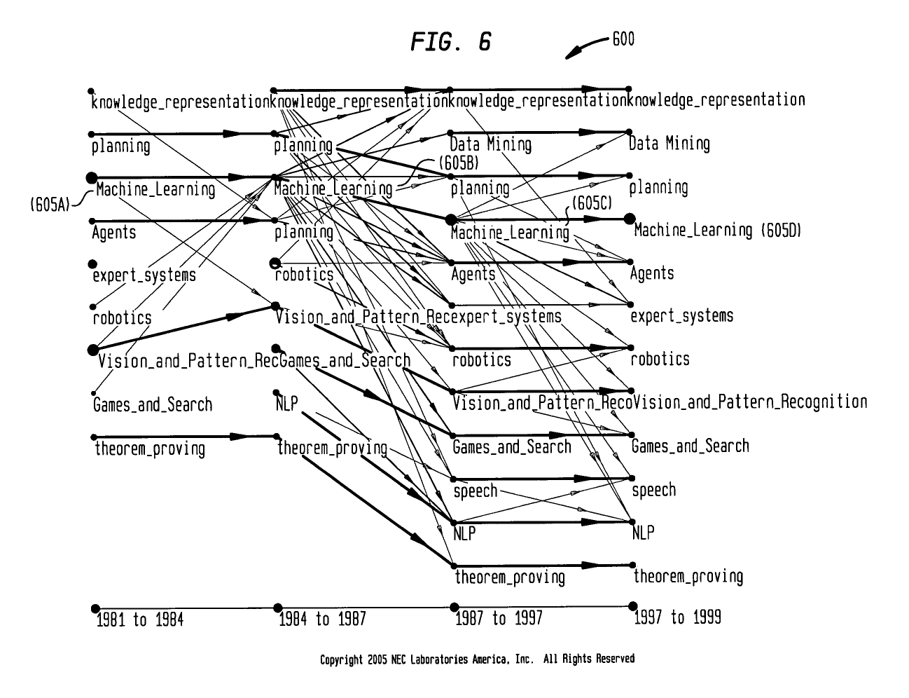

FIG. 6 sets forth an exemplary evolutionary representation 600, constructed from, for example, a computer science publication corpus in the particular area of the artificial intelligence community. From FIG. 6, one can analyze the temporal evolution of the artificial intelligence community. During the period of 1981-1984, nine research areas existed in the artificial intelligence community. Later on, new research areas appear over time. It can also be ascertained as to what areas contribute significantly (and act as a sort of “ancestor”) to others by the citation analysis mentioned above in building the evolutionary ExpertiseNet. Overall, “Machine learning” (605) may be established from FIG. 6 as the foundation of many other research areas in artificial intelligence. The meanings of the links and their strength shown by thickness as well as the strength of the nodes shown by size, are the same as we mentioned earlier in building the evolutionary ExpertiseNet.

After obtaining the relational representations and evolutionary representations of a variety of entities, one can then perform expertise mining and matching. In accordance with another aspect of the invention, a variety of mining and matching may be conducted. One exemplary mining technique, for example, is to conduct a search for entities who not only have the expertise of interest but who also have expertises that satisfy certain relational patterns between the relevant expertises. This approach may be referred to as “expertise relationship mining.” Another approach is to find entities who have certain evolutionary expertise patterns. This approach may be referred to as “evolutionary expertise mining.” The searching results may be ranked, for example, by the strength of the linkage in the relational or evolutionary expertise patterns, which is calculated by the methods mentioned earlier in building the ExpertiseNet.

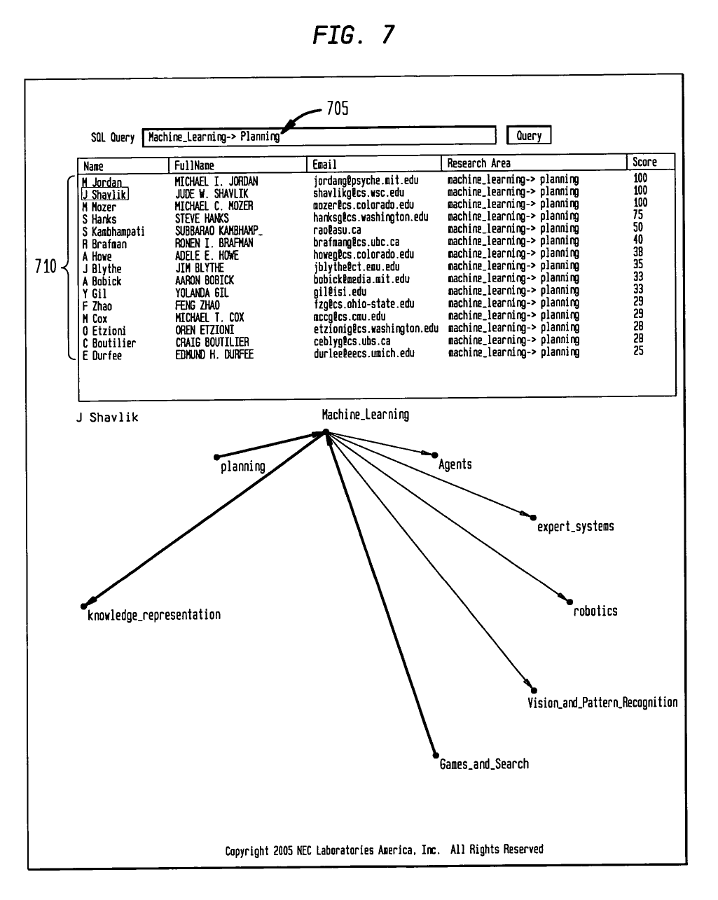

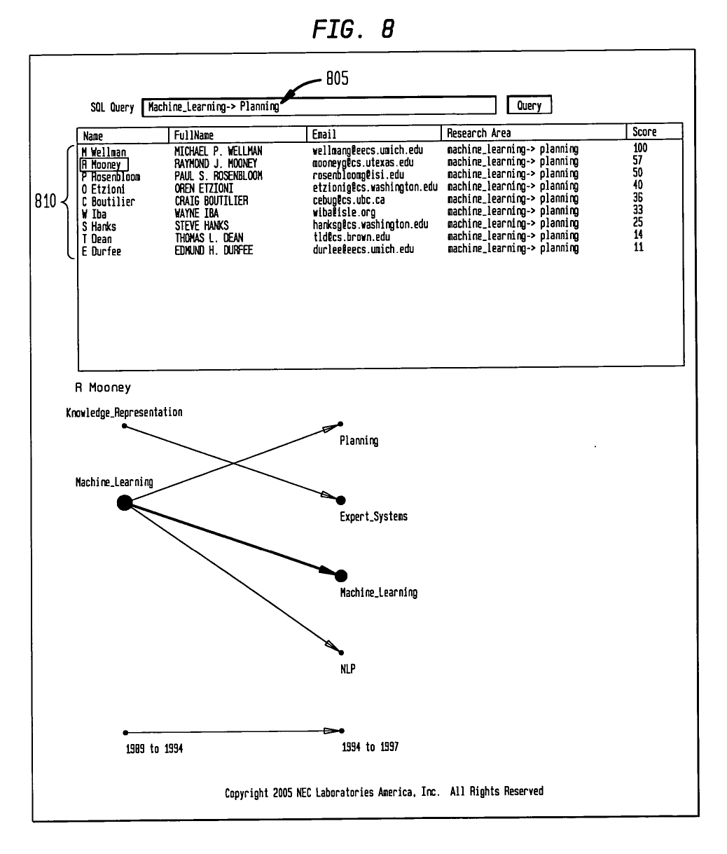

FIGS. 7 and 8 illustrate these exemplary forms of expertise mining. In FIG. 7, what is input is a query 705 that includes “machine learning” with a relationship to “planning.” In this case a “dash” has significance and may be defined and used in the SQL query line 705 to indicate that the user wishes to determine whether a relationship exists for certain people between two categories, machine learning and planning. The database to which the query is made may be in a computer system or accessed somewhere on the Internet. The input screen may be accessed via, for example, a personal computer accessing a web page or web site, be a stand alone computer with the database and program loaded therein. What is output is a list 710 of individuals with expertise in the areas “machine learning” and “planning” where the two areas have close correlation and interact with each other. The knowledge management system herein described may provide a dynamic model of semantics evolution in which expertise as well as inter-conceptual relationships exhibits.

In FIG. 8, the query 805 that is input is “machine learning→planning”. In this case an “arrow” has significance and may be defined and used in the SQL query line 805 to indicate that the user wishes to determine whether an evolutionary relationship exists for certain people between two categories, machine learning and planning. A list 810 of persons with expertise in “machine learning” in an earlier stage and an expertise in “planning” in a later stage is output. The highlighted person's evolutionary information is displayed, showing that the person's previous expertise contributes to their later understanding of “planning.” The knowledge management system thereby provides a dynamic model of semantics evolution in which expertise and/or evolutionary behavior may be exhibited.

One can also conduct novel forms of expertise matching, in which a search is made to find entities/persons with similar expertise. Instead of using traditional vector-based matching, the present invention may provide various ways to search entities with similar evolutional and/or relational information of the expertises. For example, and without limitation, the expertise profiles may be compared based on a generalized hamming distance function, which considers both the weighted linkages and weighted nodes into the computation, to compare different expertise profiles in order to differentiate different entities. For example, this distance can be expressed as follows:

$$dist ( {G}_{1} , {G}_{2} ) = {\sum }_{t = 1}^{W} \vert {V}_{t}^{1} - {V}_{t}^{2} \vert + β {\sum }_{i = 1}^{W} {\sum }_{{j = 1}_{j \neq i}}^{W} \vert {E}_{ij}^{1} - {E}_{ij}^{2} \vert$$

where G, V, E indicate graph, node, and edge respectively, w indicates the number of nodes in the graph, and β0 is a weight to determine the trade-off of the importance of the nodes or structure. The similarity between expertise profiles may be based on various kinds of indices which are extracted from the expertise representations and the semantic labels of the nodes, e.g., based on degree-based, betweenness-based, closeness-based, flow-based centrality and prestige indices, structural balance, clusterability, and transitivity indices, and/or the cohesiveness of subgroups.

In a variation, where an exponential random graph model is utilized, a “distance” function may be used to compare different relational representations in order to differentiate entities, for example, as defined as follows:

$$dist ( {G}_{1} , {G}_{2} ) = {\sum }_{k = 1}^{M} \vert {θ}_{1 , k} - {θ}_{2 , k} \vert$$

where G indicate the graphs, θ indicates the parameters of the exponential random graph models, and M represents the number of parameters to describe one graph. For evolutionary representations of the expertise information, the distance function may be formulated as:

$$dist ( {G}_{1} , {G}_{2} ) = {\sum }_{k = 1}^{L} \vert {β}_{1 , k} - {β}_{2 , k} \vert$$

where β are the statistical parameters in the actor-oriented model.

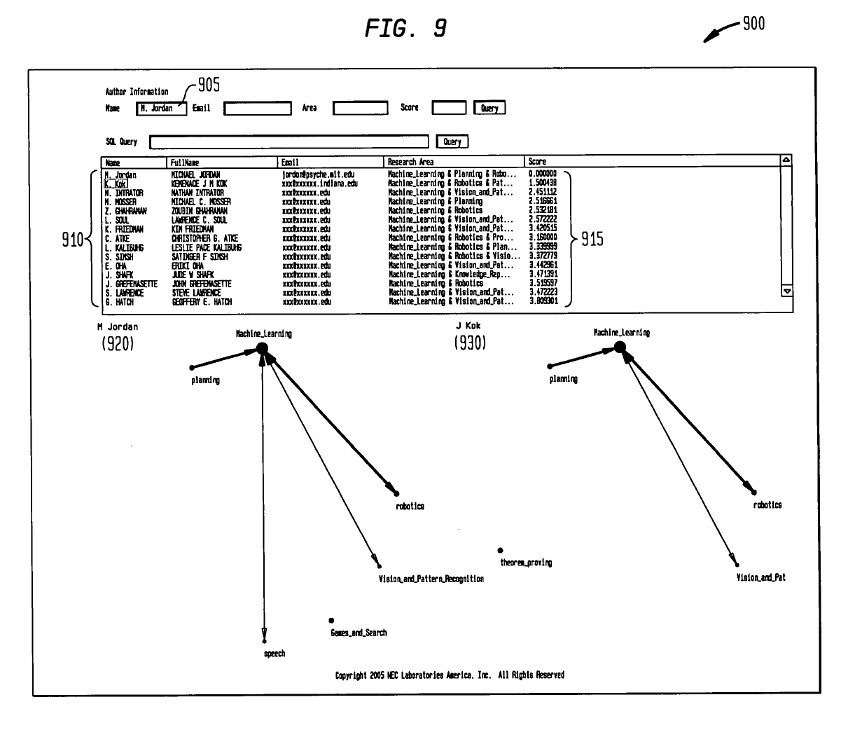

FIG. 9 illustrates one way how expertise matching 900 can be used to find persons with similar expertise and relationship among expertises as the person used for matching. For example, a person 905 may be selected with the displayed expertise information. What is output may be a list 910 of persons ranked according to their similarity to the identified person's expertise information. People may be ranked by the scores 915 which may represent the distance between two persons in terms of relational ExpertiseNet. In this example, Jordan 920 has six expertises as machine learning, planning, robotics, vision and pattern recognition, games and search, and speech, where machine learning is the central expertise and influences others significantly (represented by the width of the link or edge), and game and search is a relatively independent expertise without any interaction with others (having no link or edge connecting it to the other nodes of the network). Among all the people in the database, Kok 930 has the most similar expertises in terms of relational ExpertiseNet as Jordan's 920, thus ranks the highest in the query result except Jordan himself. For both of them, machine learning is a central area and machine learning, planning, robotics, and vision and pattern recognition are four significant expertises with similar relationship.

Compared to a mining/matching process based on traditional expertise profiles, which obtain a long list with persons with similar expertise as the result, the present invention may be able to generate a much smaller list with more accurate matching for the requirement(s), thereby saving time in a mining process. User models described by the above-mentioned relational representions and evolutionary representations provide a rich and accurate representation for expertise profiles, and may be used in different applications such as mining, retrieval, and visualization of the information. The expertise may be built up in a hierarchical way. The relationships and correlations across heterogeneous information sources related to an entity can be readily extracted. Consider, for example, a manager who has a project which needs to use machine learning to solve problems in computer vision. Using a traditional system, the manager would type in keywords “machine learning” and “computer vision” and get a list with many people with similar expertise. How does the manager differentiate them? With a relationship representation, the manager will be able to identify an entity who is, for example, using “machine learning” for “NLP” while another entity is using “computer vision” with “machine learning” and doing “NLP” independently. With a representation generated for a whole community, one can readily do a search for related research areas and obtain key references automatically and/or search for individuals with similar expertise profiles and, thereby, obtain useful suggestions for potential future projects. As a result, it may be possible to classify expertise areas and predict trends in the expertise areas.

While exemplary drawings and specific embodiments of the present invention have been described and illustrated herein, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow and their structural and functional equivalents.

What is claimed is:

1. A method, comprising the steps of:
defining one or more information profiles having particular data attributes to be analyzed;
analyzing selected data attributes from the one or more information profiles; and
constructing an evolutionary representation of the selected data attributes.

2. The method of claim 1, wherein the step of constructing an evolutionary representation of selected data attributes includes the steps of:
deriving evolution segmentation by detecting change points over time for a first data set; and
deriving evolution tracking by determining a correlation between a second data set and at least a portion of the first data set.

3. The method of claim 2, wherein the first data set includes citations to prior documents and the second data set includes information regarding development over time of subject matter areas.

4. The method of claim 3, wherein the method is for knowledge management and evolution of expertise is analyzed.

5. The method of claim 1, wherein the evolutionary representation is one or more graph(s).

6. The method of claim 5, wherein dynamics and evolution of expertise are analyzed and presented in the one or more graph(s).

7. The method of claim 1, further comprising the step of:
constructing a relationship representation derived from the selected data attributes.

8. The method of claim 7, wherein the relationship representation is a relational graph having one or more nodes indicative of particular characteristic(s) of one or more of the selected data attributes, and one or more links indicating correlation between the particular characteristic(s).

9. The method of claim 8, wherein the one or more nodes represent the knowledge of a person in a research area and the one or more links indicate the correlation between different expertise.

10. The method of claim 9, wherein the selected data attributes include citations and/or text similarity.

11. The method of claim 7, wherein the selected data attributes include citations and/or text similarity.

12. The method of claim 11, wherein the text similarity is determined using latent semantic analysis (LSA).

13. The method of claim 7, wherein the relationship representation is a relational graph for user modeling.

14. A method, comprising the steps of:
defining one or more information profiles having particular data attributes to be analyzed;
analyzing selected data attributes from the one or more information profiles; and
constructing a relational representation of the selected data attributes.

15. The method of claim 14, further comprising the step of:
constructing an evolutionary representation of the selected data attributes.

16. The method of claim 15, further comprising the step of:
constructing a characteristic profile of the selected data attributes, the profile consisting of the relational representation and the evolutionary representation.

17. The method of claim 16, further comprising the step of:
mining the characteristic profile for particular characteristic(s).

18. The method of claim 17, further comprising the step of:
matching desired characteristic(s) with the characteristic(s) found in the profile using the relational representation and the evolutionary representation.

19. The method of claim 14, further comprising the step of:
performing link analysis and/or text analysis so as to construct the relational representation and/or the evolutionary representation.

20. The method of claim 19, wherein the relational representation has one or more nodes indicative of particular characteristic(s) of one or more of the selected data attributes, and one or more links indicating correlation between the particular characteristic(s).

21. The method of claim 15, wherein the step of constructing an evolutionary representation of selected data attributes includes the steps of:
deriving evolution segmentation by detecting change points over time for a first data set; and
deriving evolution tracking by determining a correlation between a second data set and at least a portion of the first data set.

22. The method of claim 21, wherein the first data set includes citations to prior documents and the second data set includes information regarding development over time of subject matter areas.

23. The method of claim 22, wherein the method is for knowledge management and evolution of expertise is analyzed.

24. The method of claim 23, wherein the evolutionary representation is one or more graph(s).

25. The method of claim 24, wherein dynamics and evolution of expertise are analyzed and presented in the one or more graph(s).

26. A system, comprising:
a data extractor that extracts information from relational data and/or temporal evolution data, so as to develop a relationship representation and/or an evolutionary representation of the information.

27. The system of claim 26, further comprising:
a network generator that combines the relationship representation and/or an evolutionary representation to form an information profile.

28. The system of claim 27, wherein the relationship representation and/or an evolutionary representation may be developed by analyzing data using text analysis and/or link analysis.

29. The system of claim 28, wherein the information profile is a combined representation of expertise of one or more entities.

30. The system of claim 26, wherein the relationship representation and/or an evolutionary representation is generated using a probabilistic graphical model.

31. The system of claim 28, further comprising:
a data mining module that mines the information profile for particular data based on a query; and
a data matching module that matches and outputs a result based on the matching of particular data input via the query, wherein the output may include a graphical representation of the interrelationships of related data extracted from the analyzed data.

32. A computer readable medium upon which is embedded a sequence of programmed instructions which when executed by a processor will cause the processor to perform the following steps comprising:
defining one or more information profiles having particular data attributes to be analyzed;
analyzing selected data attributes from the one or more information profiles; and
constructing an evolutionary representation of the selected data attributes.

33. The computer readable medium of claim 31, wherein the step of constructing an evolutionary representation of selected data attributes includes the steps of:
deriving evolution segmentation by detecting change points over time for a first data set; and
deriving evolution tracking by determining a correlation between a second data set and at least a portion of the first data set.

34. The computer readable medium of claim 32, wherein the first data set includes citations to prior documents and the second data set includes information regarding development over time of subject matter areas.

35. The computer readable medium of claim 33, upon which is embedded programmed instructions which when executed by a processor will cause the processor to perform the following further steps comprising:
constructing a relationship representation derived from the selected data attributes.

36. The computer readable medium of claim 34, wherein the relationship representation is a relational graph having one or more nodes indicative of particular characteristic(s) of one or more of the selected data attributes, and one or more links indicating correlation between the particular characteristic(s).

37. The computer readable medium of claim 35, wherein the one or more nodes represent the knowledge of a person in a expertise area and the one or more links indicate the correlation between different expertise.
